(19) United States
(12) Patent Application Publication
(10) Pub. No.: US 2016/0379365 A1
(43) Pub. Date: Dec. 29, 2016

(54) CAMERA CALIBRATION DEVICE, CAMERA CALIBRATION METHOD, AND CAMERA CALIBRATION PROGRAM

(71) Applicant: KABUSHIKI KAISHA TOPCON, Itabashi-ku (JP)

(72) Inventors: You SASAKI, Itabashi-ku (JP); Tadayuki Ito, Itabashi-ku (JP)

(73) Assignee: KABUSHIKI KAISHA TOPCON, Itabashi-ku (JP)

(21) Appl. No.: 15/172,935

(22) Filed: Jun. 3, 2016

(30) Foreign Application Priority Data
Jun. 26, 2015 (JP) 2015-128494

(51) Int. Cl. G06T 7/00; G06T 7/20

(52) U.S. Cl. CPC G06T 7/0018; G06T 7/004; G06T 7/20; G06T 2207/20224; G06T 2207/30244; G06T 2207/30252

(57) ABSTRACT

A technique is disclosed for easily performing calibration of a camera by using a MMS. A calibration device for a camera that is configured to photograph the sun includes an in-image sun position identifying unit 115, a sun position estimating unit 113, and a camera attitude calculating unit 116. The in-image sun position identifying unit 115 identifies a position of the sun in an image that is photographed by the camera. The sun position estimating unit 113 estimates a position of the sun in the image based on orbital information of the sun. The camera attitude calculating unit 116 calculates attitude of the camera based on differences between identified positions and the estimated positions of the sun in the images.

### BACKGROUND OF THE INVENTION

Technical Field

The present invention relates to a technique for calibrating a camera.

Background Art

An MMS (mobile mapping system) is publicly known. In the MMS, a vehicle is equipped with a GNSS unit, a camera, a laser scanner, an IMU (Inertial Navigation Unit), etc., and the vehicle obtains three-dimensional data and images of the surroundings while travelling, whereby a three-dimensional data of the travelling environment is obtained. The three-dimensional data that is obtained by the MMS may be used for city planning, civil engineering work, disaster prevention plans, etc., for example.

In the MMS, the precision of exterior orientation parameters (position and attitude) of the camera relative to the vehicle is important. The work for obtaining the exterior orientation parameters of the camera relative to the vehicle is called “calibration”. If a camera is initially fixed on a vehicle, the calibration can be performed when the vehicle is shipped. However, when a camera is mounted on a vehicle after the vehicle is shipped and when the position or the attitude of the camera is changed, a user should perform the calibration. The technique for calibrating a camera by using the MMS may be found in Japanese Unexamined Patent Application Laid-Open No. 2012-242317, for example.

### SUMMARY OF THE INVENTION

For the calibration of a camera, dedicated control points must be prepared, and the work for the calibration is complicated. In view of these circumstances, an object of the present invention is to provide a technique for easily performing calibration of a camera by using a MMS.

A first aspect of the present invention provides a calibration device for a camera that is configured to photograph the sun, and the calibration device includes a sun position identifying unit, a sun position estimating unit, and a camera attitude calculating unit. The sun position identifying unit identifies a position of the sun in an image that is photographed by the camera. The sun position estimating unit estimates a position of the sun in the image based on orbital information of the sun. The camera attitude calculating unit calculates attitude of the camera based on difference between the identified position and the estimated position of the sun in the image.

According to the first aspect of the present invention, by using the sun, of which the position on the celestial sphere surface can be precisely calculated, as a control point, calibration is performed for calculating the attitude of the camera. When the position of the sun in the image that is photographed by the camera is calculated from the orbital information of the sun, information of the attitude of the camera (direction in which the camera faces) is used. Therefore, when the attitude information of the camera contains uncertainties, an estimated position of the sun in the image, which is calculated from the attitude information, does not correspond to the observed position of the sun in the image. Accordingly, by searching parameters, which determine the attitude of the camera, so as to eliminate the difference between the estimated position and the observed position in the image, the attitude of the camera can be precisely calculated.

According to a second aspect of the present invention, in the invention according to the first aspect of the present invention, the camera attitude calculating unit may calculate the attitude of the camera by using at least one of a condition in which the difference becomes minimum, a condition in which the difference becomes not greater than a predetermined value, and a condition in which correction amounts that determine the difference are converged to predetermined values.

According to a third aspect of the present invention, in the invention according to the first or the second aspect of the present invention, the camera attitude calculating unit may evaluate a difference between a first vector, which specifies the direction of the sun in the image, and a second vector, which specifies the direction of the estimated position of the sun, and the second vector contains information of set values of the attitude of the camera.

A fourth aspect of the present invention provides a method for calibrating a camera that is configured to photograph the sun, and the method includes identifying a position of the sun in an image that is photographed by the camera, estimating a position of the sun in the image based on orbital information of the sun, and calculating the attitude of the camera based on difference between the identified position and the estimated position of the sun in the image.

A fifth aspect of the present invention provides a computer program product including a non-transitory computer-readable medium storing computer-executable program codes for calibrating a camera that is configured to photograph the sun. The computer-executable program codes include program code instructions for identifying a position of the sun in an image that is photographed by the camera, estimating a position of the sun in the image based on orbital information of the sun, and calculating the attitude of the camera based on difference between the identified position and the estimated position of the sun in the image.

According to the present invention, a technique for easily performing the calibration of a camera by using the MMS is provided.

### BRIEF DESCRIPTION OF DRAWINGS

FIG. 1 shows an example of a vehicle that is equipped with a camera.

FIG. 2 is a block diagram of an operating device in an embodiment.

FIG. 3 is a flow chart showing an example of a processing procedure.

FIG. 4 is a conceptual diagram exemplifying a relationship between an estimated position and an observed position of the sun in an image.

FIG. 5 is a conceptual diagram exemplifying a relationship between estimated positions and observed positions of the sun in an overlaid image.

FIG. 6 is a conceptual diagram exemplifying a relationship between estimated positions and observed positions of the sun in an overlaid image.

### PREFERRED EMBODIMENT OF THE INVENTION

### Outline

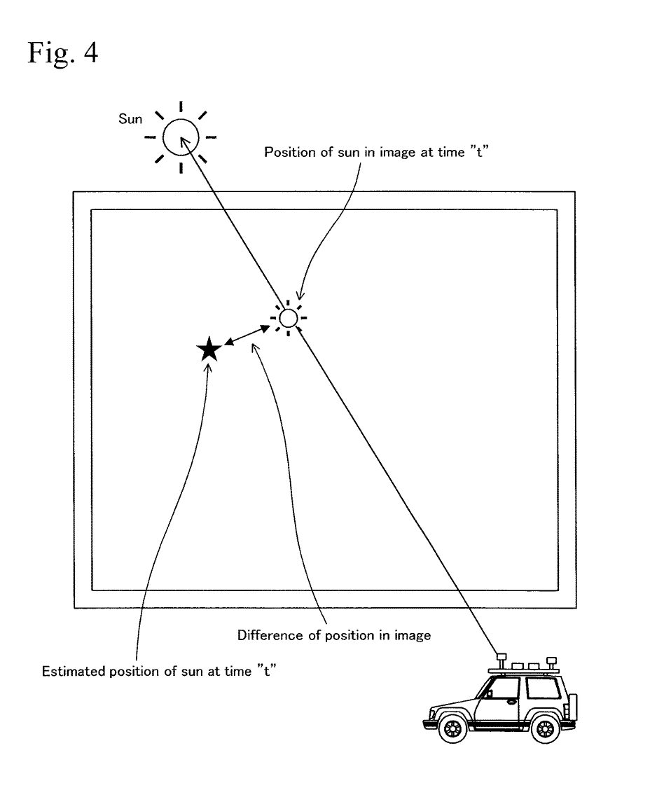

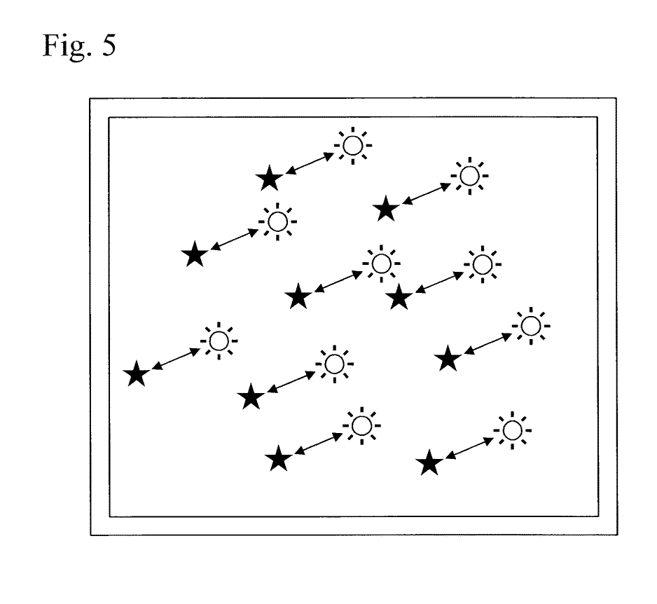

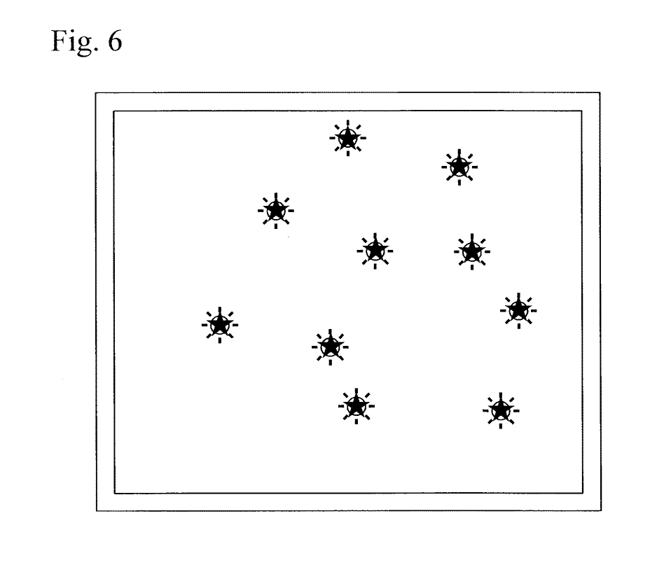

In this embodiment, calibration for calculating the attitude (direction) of a camera is performed by using the sun in images that are photographed by the camera at different times. Hereinafter, the principle will be described briefly. FIG. 4 shows an estimated position of the sun in a still image, in which the direction of the sun is photographed, and shows an observed position of the sun in the still image. When the attitude information of the camera that is used for the photographing contains uncertainties, the estimated position of the sun tends to differ from the true value. Therefore, a difference is generated between the estimated position and the observed position of the sun in the image. In view of this, a correction amount δ is added to a parameter that specifies the attitude of the camera, and the value of the correction amount δ is calculated so that the positional difference will satisfy a convergence condition (for example, the positional difference will be minimum). Conceptually, in multiple images, the value of the correction amount δ is repeatedly corrected (in other words, searched for) so that the differences between the estimated positions and the observed positions, as shown in FIG. 5, will be eliminated as shown in FIG. 6.

### Structure

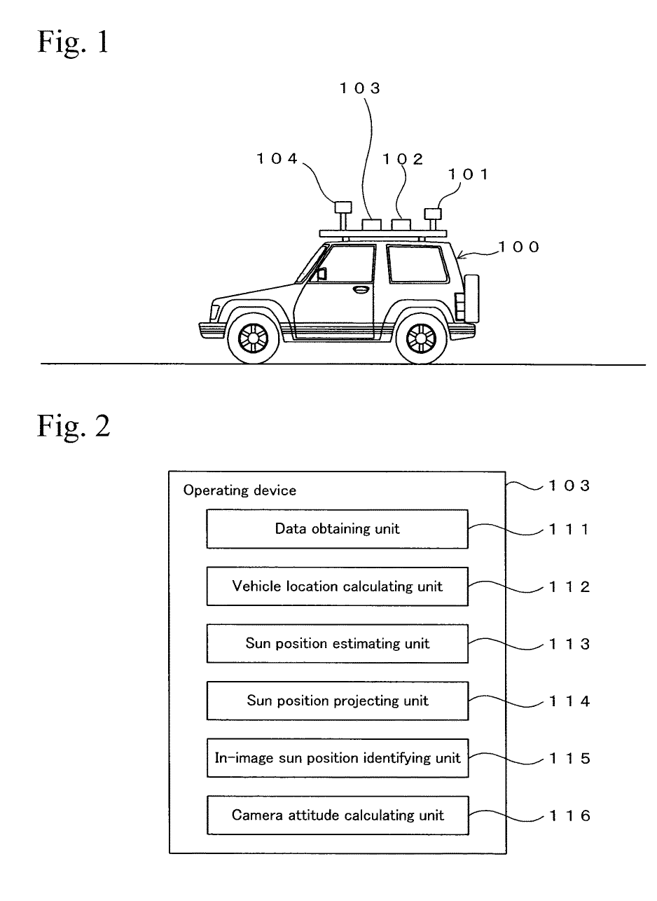

FIG. 1 shows a vehicle 100 that is equipped with an antenna 101, an IMU 102, an operating device 103, and a camera 104. The antenna 101 receives navigation signals from a navigation satellite such as a GPS satellite or the like. The navigation signals contain transmission times of the navigation signals, orbital information of the navigation satellite, code information that is used for measuring propagation times of the navigation signals and the like, etc. The applicable navigation satellite is not limited to a GPS satellite and may be a navigation satellite of another type. As the navigation satellite, a navigation satellite that complements a GPS system may also be used. This type of navigation satellite includes a navigation satellite that is controlled by a qusai-zenith satellite system.

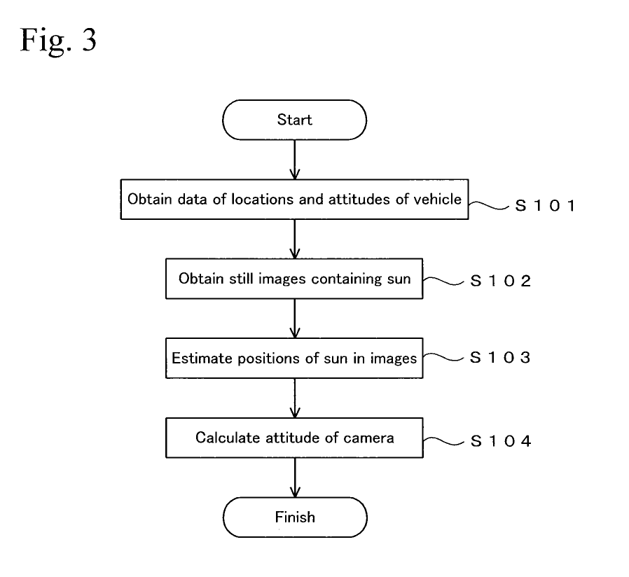

The IMU (Inertial Measurement Unit) 102 is an inertial navigation unit, and it measures changes in the vehicle attitude and detects acceleration applied to the vehicle. The operating device 103 is hardware that functions as a computer, and it has the structure shown in FIG. 2, which is described later, and performs processing shown in FIG. 3. The camera 104 is a panoramic camera and can photograph moving images of the entirety of the surroundings, including an overhead direction (2π space). The panoramic camera may be as disclosed in Japanese Unexamined Patent Applications Laid-Open Nos. 2012-204982 and 2014-071860, for example. The camera 104 consecutively photographs still images at a predetermined time interval. The camera 104 may photograph moving images. In this case, frame images constituting the moving image are used as still images.

Although not shown in the figures, a laser scanner is mounted on the vehicle 100 in addition to the camera 104. By using images that are photographed by the camera 104 and using three-dimensional point cloud position data that is obtained from the laser scanner, three-dimensional data of the circumstances in which the vehicle 100 has travelled (for example, data of a three-dimensional model of the circumstances) is obtained.

Here, the position of the antenna 101 and the position and the attitude of the IMU 102 on the vehicle 100 are preliminarily measured and are known. Then, in an initial condition, the position of the camera 104 relative to the vehicle 100 is already measured and is known, whereas an approximate value is determined for the attitude of the camera 104 relative to the vehicle 100 and contains uncertainties.

Hereinafter, the operating device 103 is described. The operating device 103 is hardware that functions as a computer and has each of functional units shown in FIG. 2. Each of the functional units shown in FIG. 2 may be constructed of software or may be composed of a dedicated arithmetic circuit. In addition, a functional unit that is constructed of software and a functional unit that is composed of a dedicated arithmetic circuit may be used together. For example, each of the functional units shown in FIG. 2 is composed of a CPU (Central Processing Unit), an ΔSIC (Application Specific Integrated Circuit), and a PLD (Programmable Logic Device) such as an FPGA (Field Programmable Gate Array). The operating device 103 also includes a storage unit such as a solid electronic memory, a hard disk drive, or the like, and various types of interface circuits.

FIG. 2 shows a block diagram of the operating device 103. The operating device 103 includes a data obtaining unit 111, a vehicle location calculating unit 112, a sun position estimating unit 113, a sun position projecting unit 114, an in-image sun position identifying unit 115, and a camera attitude calculating unit 116. The data obtaining unit 111 receives navigation signals that are received by the antenna 101 and also receives data of images that are photographed by the camera 104.

The vehicle location calculating unit 112 calculates the location of the vehicle 100 based on the navigation signals that are received by the antenna 101 from the GNSS navigation satellite. The location of the vehicle 100 is calculated based on the position of the IMU 102. In the calculation of the location of the vehicle 100, various kinds of beacon signals may also be used in addition to the data of the GNSS. As an applicable system in addition to the GNSS, a VICS (Vehicle Information and Communication System) (registered trademark) may be described. The location and attitude of the vehicle can also be calculated by using moving images that are photographed by the camera. This technique is disclosed in Japanese Unexamined Patent Application Laid-Open No. 2013-186816, for example.

The sun position estimating unit 113 estimates the position of the sun on the celestial sphere surface, which is viewed from the vehicle 100 (in this case, the position of the IMU 102). In this case, since the sun can be considered as being located at an infinite distance, the position of the sun on the celestial sphere surface is the same when the sun is viewed from the vehicle 100 and when the sun is viewed from the camera 102. The position of the sun can be estimated after the location of the vehicle 100 and the time when the vehicle 100 is at the location are determined. In the estimation of the position of the sun, a dedicated program is used. The orbital information of the sun on the celestial sphere surface can be obtained from publicly known astronomical information. The orbital information of the sun can be obtained from a website of the Jet Propulsion Laboratory (U.S.) (http://www.jpl.nasa.gov/), for example. In addition, the method of estimating the position of the sun may be found in the Proceedings of Annual Research Meeting, Tohoku Chapter, Architectural Institute of Japan (68), published on Jun. 10, 2005, (news-sv.aij.or.jp/kankyo/s13/OLDHP/matsu0512.pdf), for example.

The sun position projecting unit 114 projects the estimated position of the sun on the image that contains the sun. The camera attitude calculating unit 116 calculates the attitude of the camera 104 by using differences between the estimated positions and the observed positions of the sun in the images. The in-image sun position identifying unit 115 obtains a position (in-image position) of the sun in a target still image that contains the sun. Specifically, information of coordinates of the sun image in the target still image is obtained.

### Example of Processing

FIG. 3 shows an example of a processing procedure that is performed by the operating device 103. Programs for executing the processing shown in FIG. 3 are stored in a memory in the operating device 103 or an appropriate storage medium and are executed by the operating device 103. First, information of location and attitude of the vehicle 100 at a time “t” is obtained (step S101). The processing of this step is performed by the data obtaining unit 111. The value of the location of the vehicle 100 is obtained by the calculation that is performed by the vehicle location calculating unit 112, and the value of the attitude of the vehicle 100 is obtained from the IMU 102. Moreover, data of still images that are photographed by the camera 104 at time “t” is obtained (step S102). Here, an image containing the sun is selected as a target still image. In addition, since sunlight is extremely bright, appropriate filtering is performed, and the lightness of the target still image is adjusted so that the position of the sun is clearly obtained. After the image that contains the sun is selected, a position of the sun image in the target still image is obtained. The processing of this step is performed by the in-image sun position identifying unit 115.

Next, the position of the sun on the celestial sphere surface is estimated (step S103). The processing of this step is performed by the sun position estimating unit 113. The direction of the sun that is viewed from the vehicle 100 is determined from the position of the sun on the celestial sphere surface. The position of the sun may be obtained from a data base or may be obtained via communication lines after it is calculated by an external server or the like.

Then, the attitude of the camera is calculated (step S104). The processing of this step is performed by the camera attitude calculating unit 116. Hereinafter, details of the processing that is performed in step S104 is described. First, the location of the vehicle 100 at time “t” is represented by Pimu(t). Here, since the attitude of the vehicle 100 is obtained in step S101, and the position of the sun as viewed from the vehicle 100 is estimated in step S103, a value of a sun direction vector St_imu(t) in an IMU (vehicle) coordinate system at time “t” is obtained. The IMU (vehicle) coordinate system is fixed relative to the vehicle while the position of the IMU is set as the origin, and it moves in parallel and rotates in conjunction with the vehicle.

The sun direction vector St_imu(t) is a unit vector that specifies the estimated direction of the sun in the IMU coordinate system at time

The position of the camera 104 in the IMU (vehicle) coordinate system is represented by “T” (translation vector), and the attitude of the camera 104 is represented by “R” (rotation matrix). Here, the value of “R” is determined by three components of roll, pitch, and yaw. In the initial stage, an approximate direction of the camera 104 relative to the vehicle is determined, but a precise value is not known, and the value of “R” contains calibration error. The calibration error (correction amount for obtaining a true value) is set as an unknown parameter. By representing a sun direction vector that specifies an estimated direction of the sun in a camera coordinate system at time “t” by St_cam(t), the First Formula is established. The sun direction vector St_cam(t) is a unit vector that specifies the estimated direction of the sun in the camera coordinate system at time “t”. The camera coordinate system is fixed relative to the camera 103 while the position of the camera 103 is set as the origin, and it moves in parallel and rotates in conjunction with the camera 103.

St_cam(t)=R(roll, pitch, yaw)×St_imu(t)+T First Formula

An observed position of the sun in the target still image is identified by using the target still image that is photographed by the camera 104 and that is obtained in step S102. This calculation is performed by the in-image sun position identifying unit 115. Since the camera coordinate system is a coordinate system that is fixed relative to the camera 104, the relationship between the target still image and the camera coordinate system is determined. Therefore, by identifying the observed position of the sun in the target still image, a sun direction vector Si_cam(t) for specifying an actual photographing direction of the sun in the camera coordinate system is identified. The sun direction vector Si_cam(t) is a unit vector that specifies the actual photographing direction (observed direction) of the sun in the camera coordinate system at time “t”. Here, by representing a difference between the two vectors of St_cam(t) and Si_cam(t) by ΔS, the Second Formula is established.

ΔS=St_cam(t)−Si_cam(t) Second Formula

The difference ΔS is a parameter that is the difference between the estimated position and the observed position of the sun in the target still image. The Third Formula is thereby obtained from the First Formula and the Second Formula.

ΔS=R(roll, pitch, yaw)×St_imu(t)+T−Si_cam(t) Third Formula

Here, by respectively representing correction amounts from initial values (design values or approximate values that are initially set) of the unknown parameters of roll, pitch, and yaw by δroll, δpitch, and δyaw, a linearized formula shown by the following Fourth Formula is developed. Here, the symbol “[ ]^{T}” represents transposition, and the symbol “J” represents a Jacobian matrix.

ΔS=J[δroll, δpitch, δyaw]^{T} Fourth Formula

By representing b=ΔS, A=J, x=[δroll, δpitch, δyaw]^{T} in the Fourth Formula, the Fifth Formula is obtained.

b=Ax Fifth Formula

The Fifth Formula is an observation equation for evaluating the difference between the sun direction vector, which is calculated from the sun orbit, and the sun direction vector, which is calculated by using the observed position of the sun in the target still image. That is, the Fifth Formula is an observation equation for evaluating the difference between the estimated position of the sun on the celestial sphere surface, which is calculated from the sun orbital data, and the observed position of the sun on the celestial sphere surface

After the observation equation of the Fifth Formula is established, a value of each of the parameters at multiple photographing timings is substituted into the observation equation. For example, values of St_cam(t) and St_imu(t) at times t1, t2, t3, . . . , and to are substituted into the observation equation of the Fifth Formula. Here, the number “n” of times is preferably selected to be as great as possible in an acceptable range. Thereafter, a normal equation is obtained by the following steps. First, the Fifth Formula is multiplied by a transposed matrix A^{T} of the matrix A from the left side, whereby the Sixth Formula is obtained.

A^{T}b=A^{T}Ax Sixth Formula

Then, the Sixth Formula is multiplied by an inverse matrix (A^{T}A)⁻¹ of the matrix A^{T}A from the left side, whereby the Seventh Formula (normal equation) is obtained.

(A^{T}A)⁻¹·A^{T}b=x Seventh Formula

Least squares solutions of the correction amounts δroll, δpitch, and δyaw from the initial values are obtained from the Seventh Formula. Then, if the convergence condition is satisfied, the obtained correction amounts δroll, δpitch, and δyaw are adopted, and the processing is finished. Otherwise, the processing goes to the step described below. As the convergence condition, a condition in which the value of the vector difference ΔS comes to be not greater than a predetermined threshold value or a condition in which the value of the vector difference ΔS cannot be made smaller (the value of ΔS is minimum) may be described. In addition, a condition, in which the correction amounts δroll, δpitch, and δyaw converge to particular values, can also be used as the convergence condition. More than one of these described convergence conditions may be used together. For example, correction values may be adopted when at least one of the multiple convergence conditions is satisfied, or correction values may be adopted when at least two of the multiple convergence conditions are satisfied.

If the convergence condition is not satisfied, the values of δroll, δpitch, and δyaw that are obtained at this stage are used in the initial value of “R” as new correction amounts, and the sun direction vector is recalculated from the sun orbit by using the new value of “R”. That is, the values of δroll, δpitch and δyaw that are obtained at this stage are combined in the initial value of “R”, and a new initial value of “R” is set. Then, the value of ΔS is recalculated, and the calculation of the Fourth Formula and the subsequent calculations are performed again. By repeating this loop processing until the convergence condition is satisfied, correction amounts δroll, δpitch, and δyaw that are closer to the true values are obtained. Thus, the unknown value of “R” is determined, and the attitude of the camera 104 relative to the vehicle 100 is calculated. Normally, processing for converging the values of δroll, δpitch, and δyaw to the true values is performed by repeating the loop of the above calculations.

### Advantages

According to the above technique, by using the sun as the reference point for orientation, data of the attitude of the camera 104 relative to the vehicle 100 is obtained. In this technique, a dedicated orientation target is not used, and complicated operations are not required. Therefore, the calibration of a camera using the MMS is easily performed.

### Other Matters

The present invention is not limited to the processing for calculating the attitude of a camera relative to a vehicle that is equipped with the camera and may be used with respect to a camera which is mounted on a mobile body such as an aircraft, a vessel, or the like. Here, each of a manned mobile body and an unmanned mobile body can be used. In addition, the moon can be used instead of the sun. In this case, the position of the moon is estimated from orbital information of the moon and is projected on a photographed still image. Then, the estimated position of the moon is compared with the observed position of the moon in the still image, and the processing is performed as in the case of using the sun, whereby the attitude of the camera relative to the mobile body is calculated.

What is claimed is:

1. A calibration device for a camera that is configured to photograph the sun, the calibration device comprising:
a sun position identifying unit configured to identify a position of the sun in an image that is photographed by the camera;
a sun position estimating unit configured to estimate a position of the sun in the image based on orbital information of the sun; and
a camera attitude calculating unit configured to calculate attitude of the camera based on difference between the identified position and the estimated position of the sun in the image.

2. The calibration device according to claim 1, wherein the camera attitude calculating unit calculates the attitude of the camera by using at least one of a condition in which the difference becomes minimum, a condition in which the difference becomes not greater than a predetermined value, and a condition in which correction amounts that determine the difference are converged to predetermined values.

3. The calibration device according to claim 1, wherein the camera attitude calculating unit evaluates a difference between a first vector and a second vector, the first vector specifies the direction of the sun in the image, the second vector specifies the direction of the estimated position of the sun, and the second vector contains information of set values of the attitude of the camera.

4. A method for calibrating a camera that is configured to photograph the sun, the method comprising:
identifying a position of the sun in an image that is photographed by the camera;
estimating a position of the sun in the image based on orbital information of the sun; and
calculating the attitude of the camera based on difference between the identified position and the estimated position of the sun in the image.

5. A computer program product comprising a non-transitory computer-readable medium storing computer-executable program codes for calibrating a camera that is configured to photograph the sun, the computer-executable program codes comprising program code instructions for:
identifying a position of the sun in an image that is photographed by the camera;
estimating a position of the sun in the image based on orbital information of the sun; and
calculating the attitude of the camera based on difference between the identified position and the estimated position of the sun in the image.

6. The calibration device according to claim 2, wherein the camera attitude calculating unit evaluates difference between first vectors and second vectors, the first vector specifies the direction of the sun in the image, the second vector specifies the direction of the estimated position of the sun, and the second vector contains information of set values of the attitude of the camera.
